(19) United States
(12) Patent Application Publication
(10) Pub. No.: US 2024/0306095 A1
(43) Pub. Date: Sep. 12, 2024

(54) ELECTRONIC DEVICE PERFORMING BACK OFF AND METHOD FOR OPERATING THEREOF

(71) Applicant: SAMSUNG ELECTRONICS CO., LTD., Suwon-si (KR)

(72) Inventors: Woosik CHO, Suwon-si (KR); Seungshik SHIN, Suwon-si (KR); Sukgi HONG, Suwon-si (KR)

(21) Appl. No.: 18/598,356

(22) Filed: Mar. 7, 2024

Related U.S. Application Data
(63) Continuation of application No. PCT/KR2024/002873, filed on Mar. 6, 2024.

(30) Foreign Application Priority Data
Mar. 10, 2023 (KR) 10-2023-0031497
Mar. 30, 2023 (KR) 10-2023-0042328

(51) Int. Cl. H04W 52/20; H04W 52/36

(52) U.S. Cl. CPC H04W 52/20; H04W 52/367

(57) ABSTRACT

According to an embodiment, an electronic device may include: at least one application processor, comprising processing circuitry, at least one communication processor, comprising processing circuitry, operatively connected to at least one application processor, and at least one grip sensor operatively connected to at least one application processor. At least one application processor, individually and/or collectively, may be configured to cause the electronic device to: identify an error related to at least one of the at least one grip sensor; provide information for causing backoff to at least one communication processor, based on the identification of the error; receive the information for causing the backoff, wherein at least one communication processor, individually and/or collectively, may be configured to perform at least one operation for the backoff, based on the reception of the information for causing the backoff.

### CROSS-REFERENCE TO RELATED APPLICATIONS

This application is a continuation of International Application No. PCT/KR2024/002873 designating the United States, filed on Mar. 6, 2024, in the Korean Intellectual Property Receiving Office and claiming priority to Korean Patent Application Nos. 10-2023-0031497, filed on Mar. 10, 2023, and 10-2023-0042328, filed on Mar. 30, 2023, in the Korean Intellectual Property Office, the disclosures of each of which are incorporated by reference herein in their entireties.

### BACKGROUND

### Field

The disclosure relates to an electronic device for performing backoff of maximum transmission power limit (MTPL) or transmission power and a method of operating the same.

### Description of Related Art

A user equipment (UE) may transmit electromagnetic waves for data transmission and reception to and from a base station. The electromagnetic waves radiated from the UE may have harmful effects on the human body, and many domestic and foreign organizations are attempting to limit electromagnetic waves that have harmful effects on the human body. For example, a specific absorption rate (SAR) is a value indicating how many electromagnetic waves radiated from a mobile communication terminal are absorbed into the human body. The SAR users the unit of KW/g (or mW/g) and may refer to an amount of power (KW, W, or mW) absorbed per gram of the human body. As the issue of electromagnetic waves being harmful to the human body rises, an SAR limit reference for the mobile communication terminal has been established.

For example, when the SAR expected by transmission power is larger than a threshold value, the UE may back off the transmission power (or maximum transmission power limit (MTPL)). For example, when generation of a specific event (for example, grip, hot-spot, or proxy) is identified, the UE may transmit a communication signal with backoff power corresponding to the corresponding event or transmit a communication signal with transmission power configured based on the backed off maximum transmission power limit.

The UE may include a grip sensor for determining whether the electronic device is gripped. For example, when the grip is identified based on information provided from the grip sensor, the UE may perform at least one operation for the backoff.

### SUMMARY

According to an example embodiment, an electronic device may include: at least one application processor comprising processing circuitry, at least one communication processor, comprising processing circuitry, operatively connected to at least one application processor, and at least one grip sensor operatively connected to at least one application processor. At least one application processor, individually and/or collectively, may be configured to: identify an error related to at least some of the at least one grip sensor; and provide information for causing backoff to at least one communication processor, based on the identification of the error; wherein at least one communication processor, individually and/or collectively, may be configured to: receive the information for causing the backoff; and perform at least one operation for the backoff, based on the reception of the information for causing the backoff.

According to an example embodiment, a method of operating an electronic device including at least one application processor, at least one communication processor operatively connected to at least one application processor, and at least one grip sensor operatively connected to at least one application processor may include: identifying an error related to at least some of the at least one grip sensor by the at least one application processor; providing information for causing backoff to at least one communication processor, based on identification of the error by at least one application processor; receiving the information for causing the backoff by at least one communication processor; and performing at least one operation for the backoff, based on reception of the information for causing the backoff by at least one communication processor.

According to an example embodiment, a non-transitory computer-readable storage medium storing at least one instruction is provided. The at least one instruction may, when executed by at least one processor, individually and/or collectively, of the electronic device, cause the electronic device to perform at least one operation, the at least one operation comprising: identifying an error related to at least some of the at least one grip sensor included in the electronic device; and providing information for causing backoff, based on identification of the error by the at least one application processor.

According to an example embodiment, an electronic device may include at least one application processor, comprising processing circuitry, and at least one communication processor, comprising processing circuitry, operatively connected to the at least one application processor. At least one application processor, individually and/or collectively, may be configured to: identify an error related to at least some of at least one hardware associated with backoff of at least one communication processor; and provide information for causing backoff to at least one communication processor, based on the identification of the error; wherein at least one communication processor, individually and/or collectively, may be configured to: receive the information for causing the backoff; and perform at least one operation for the backoff, based on the reception of the information for causing the backoff.

According to an example embodiment, a method of operating an electronic device including at least one application processor and at least one communication processor operatively connected to the at least one application processor is provided. The method may include: identifying an error related to at least some of at least one hardware associated with backoff of the at least one communication processor by at least application processor; providing information for causing backoff to at least one communication processor, based on identification of the error by the at least one application processor; receiving the information for causing the backoff by at least one communication processor; and performing at least one operation for the backoff, based on reception of the information for causing the backoff by the at least one communication processor.

According to an example embodiment, a non-transitory computer-readable storage medium storing at least one instruction is provided. The at least one instruction may, when executed by at least one processor, individually and/or collectively, of the electronic device, perform at least one operation, wherein the at least one operation may include: identifying an error related to at least some of at least one hardware associated with backoff; and providing information for causing the backoff, based on identification of the error.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according various embodiments;

FIG. 2A is a block diagram illustrating an example configuration of an electronic device according to various embodiments;

FIG. 2B is a diagram illustrating a connection between a grip sensor and an antenna according to various embodiments;

FIG. 3 is a signal flow diagram illustrating an example method of operating the electronic device according to various embodiments;

FIG. 4 is a signal flow diagram illustrating an example method of operating the electronic device according to various embodiments;

FIG. 5 is a signal flow diagram illustrating an example method of operating the electronic device according to various embodiments;

FIG. 6 is a signal flow diagram illustrating an example method of operating the electronic device according to various embodiments;

FIG. 7 is a flowchart illustrating an example method of operating the electronic device according to various embodiments;

FIGS. 8A and 8B are diagrams illustrating a change in a transmission antenna according to various embodiments;

FIG. 9 is a flowchart illustrating an example method of operating the electronic device according to various embodiments;

FIG. 10 is a flowchart illustrating an example method of operating the electronic device according to various embodiments;

FIG. 11 is a flowchart illustrating an example method of operating the electronic device according to various embodiments;

FIG. 12 is a flowchart illustrating an example method of operating the electronic device according to various embodiments;

FIG. 13 is a flowchart illustrating an example method of operating the electronic device according to various embodiments;

FIG. 14 is a signal flow diagram illustrating an example method of operating the electronic device according to various embodiments; and

FIG. 15 is a diagram whether the electronic device performs backoff according to various embodiments.

### DETAILED DESCRIPTION

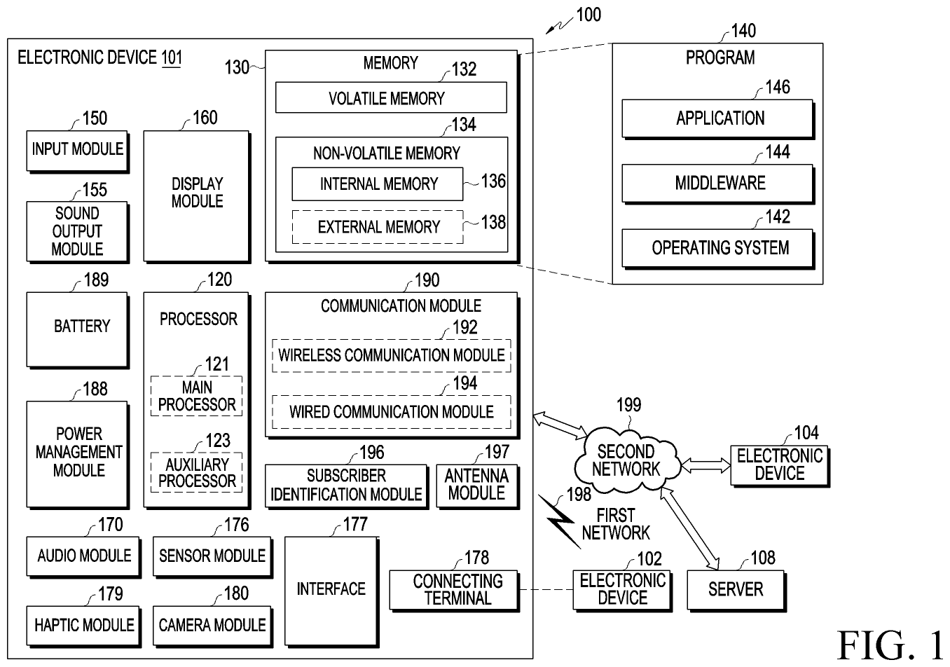

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146. The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (cMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

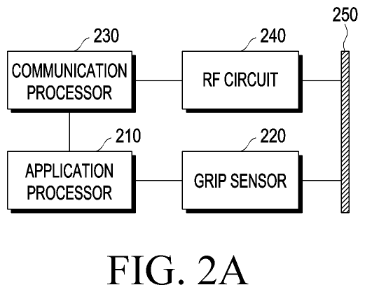

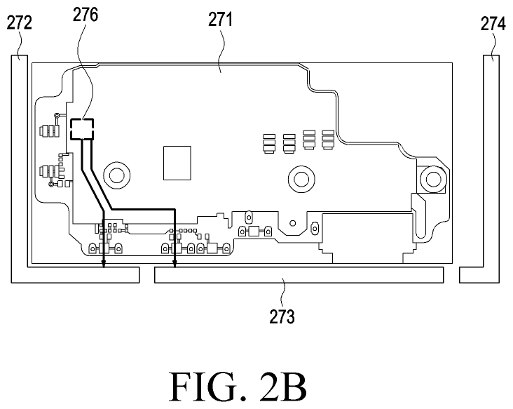

FIG. 2A is a block diagram illustrating an example configuration of an electronic device according to various embodiments. FIG. 2A is described with reference to FIG. 2B. FIG. 2B is a diagram illustrating a connection between a grip sensor and an antenna according to various embodiments.

Referring to FIG. 2A, the electronic device 101 may include an application processor (e.g., including processing circuitry) 210, a grip sensor 220, a communication processor (e.g., including processing circuitry) 230, an RF circuit 240, and at least one antenna 250.

According to an embodiment, the application processor 210 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The application processor 210 control, for example, the overall operation of the electronic device 101. For example, the application processor 210 may execute application programs executed in the electronic device 101, execute instructions (or commands), and control hardware such as the memory 130, and there is no limitation in the operation performed by the application processor 210. The application processor 210 may include, for example, a central processing unit (CPU), a graphical processing unit (GPU), a neural processing unit (NPU), and/or a digital signal processor (DSP) and/or may be combined (or connected) with at least one processing unit. The application processor 210 and the communication processor 230 may be included in, for example, the processor 120 of FIG. 1, may be independently implemented, or implemented as one hardware component.

According to an embodiment, the grip sensor 220 may be connected to the application processor 210. The grip sensor 220 may sense whether the user grips the electronic device 101. The grip sensor 220 may be connected to, for example, a conductor, and may be connected to the antenna 250 in FIG. 2B. For example, as illustrated in FIG. 2B, a grip sensor 276 disposed on a substrate 271 may be connected to two antennas, such as a first antenna 272 and a second antenna 273, but there is no limitation in the type and/or the number of connected antennas. Antennas 272, 273, and 274 may be, for example, a segmented antenna (for example, antenna radiator) but there is no limitation in the form and/or the type thereof. The grip sensor 220 may measure capacitance related to the conductor. The grip sensor 220 may identify a difference between the measured capacitance and the reference capacitance. When the identified difference satisfies a predetermined grip condition (for example, when the difference is larger than or equal to a threshold difference), the grip sensor 220 may identify grip (or that the user touches the electronic device 101). The grip sensor 220 may provide first information indicating the grip (or touch) to the application processor 210, based on the identification of the grip. The first information may be referred to as, for example, grip interrupt. When the identified difference satisfies a predetermined release condition, the grip sensor 220 may identify grip release (or that the user stops touching the electronic device 101). The grip sensor 220 may provide second information indicating the grip release (or touch release) to the application processor 210, based on the identification of the grip release. Meanwhile, an example in which the grip sensor 220 determines whether the user grips based on capacitance measurement as described above is only an example, and it may be understood by those skilled in the art that the grip sensor 220 may provide the grip or the grip release through another scheme, rather than the capacitance measurement-based scheme. The electronic device 101 may determine whether the user grips through at least one hardware other than the grip sensor 220 (for example, an acceleration sensor, a gyro sensor, and/or a geo-magnetic sensor but there is no limitation) in which case it may be understood that those skilled in the art that the electronic device 101 may be implemented to not include the grip sensor 220.

According to an embodiment, the application processor 210 may identify whether the user grips (or touches) the electronic device 101, based on information (the first information or the second information, but there is no limitation in an expression method) provided from the grip sensor 220. The application processor 210 may provide information for causing backoff to the communication processor 230, based on the identification of the grip. The information for causing the backoff may be information for causing the communication processor 230 to perform at least one operation for the backoff. In an example, the communication processor 230 may perform at least one operation for the backoff immediately after reception of the information for causing the backoff. In an example, the communication processor 230 may perform at least one operation for the backoff, based on reception of the information for causing the backoff and satisfaction of an additional condition. In an example, the information for causing the backoff may be expressed as information indicating the existence or the non-existence of grip (or touch). For example, the first information provided from the grip sensor 220 to the application processor 210 may be used as the information for causing the backoff or may be processed in another format, and it may be understood by those skilled in the art that there is no limitation in an expression method thereof. For example, the application processor 210 may transfer the received grip interrupt to the communication processor 230 through QLINK or provide information in another format for causing the backoff, based on reception of the grip interrupt.

According to an embodiment, the communication processor 230 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The communication processor 230 may control, for example, the overall operation for cellular communication. The communication processor 230 may perform at least one operation, based on, for example, a communication stack (instruction, or program) for cellular communication. The communication processor 230 may include a modem or support a function of the modem, for example, processing of a baseband signal, but there is no limitation in the operation. The RF circuit 240 may, for example, convert a baseband signal provided from the communication processor 230 to an RF signal, amplify the RF signal, and/or control (for example, switch) a path of the RF signal and include at least one radio frequency integrated circuit (RFIC) and/or at least one radio frequency front end (RFFE), but there is no limitation. The RF signal from the RF circuit 240 may be provided to the antenna 250, and an electromagnetic wave based on the RF signal may be output from the antenna 250. The communication processor 230 and/or the RF circuit 240 may control transmission power of the RF signal. The communication processor 230 and/or the RF circuit 240 may configure transmission power of the RF signal as a value equal to or smaller than a limit of the transmission power. Meanwhile, it is described that the grip sensor 220 and the RF circuit 240 share the same antenna 250 in FIG. 2A, but it is only an example and the grip sensor 220 and the RF circuit 240 may be connected to different antennas, which will be described below.

According to an embodiment, the communication processor 230 may back off the limit of the transmission power. For example, the communication processor 230 may perform at least one operation for the backoff, based on reception of the information for causing the backoff from the application processor 210. For example, the communication processor 230 may perform at least one operation for the backoff, based on reception of the information for causing the backoff from the application processor 210 and satisfaction of at least one additional condition. It may be understood by those skilled in the art that the backoff in various embodiments of the disclosure may be the limit of transmission power and/or reduction in transmission power.

For example, communication lines (for example, I2C but there is no limitation) between the grip sensor 220, the application processor 210, and the grip sensor 220 and/or hardware (for example, PMIC corresponding to the grip sensor 220) associated with the grip sensor 220 have an error, the application processor 210 may not receive the information indicating whether the user grips. In this case, the application processor 210 may not provide the information for causing the backoff to the communication processor 230, and the backoff may not be performed even though the user grips the electronic device 101. As the backoff is not performed, SAR regulations may be violated, and thus the application processor 210 according to embodiments of the disclosure may be configured to provide the information for causing the backoff to the communication processor 230, based on identification of the error associated with the grip sensor 220. Accordingly, although the error associated with the grip sensor 220 is generated, the backoff can be performed, and thus SAR regulations may not be violated.

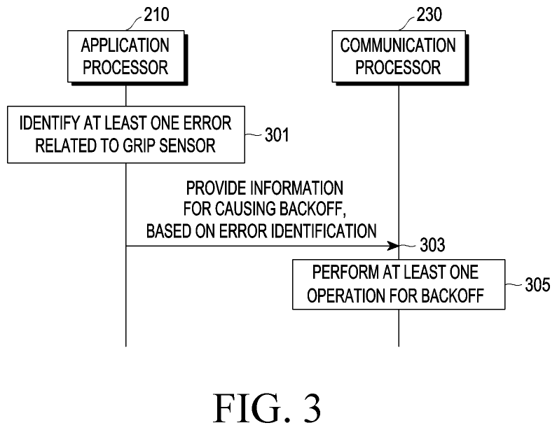

FIG. 3 is a signal flow diagram illustrating an example method of operating the electronic device according to various embodiments.

According to an embodiment, an application processor 210 may identify at least one error related to the grip sensor 220 in operation 301. In an example, the application processor 210 may identify an error related to the grip sensor 220, based on information provided from the grip sensor 220. For example, the grip sensor 220 may identify its own error of the grip sensor 220 and provide information indicating generation of the error to the application processor 210. In an example, the application processor 210 may identify the error related to the grip sensor 220, based on communication with the grip sensor 220. For example, the application processor 210 may identify whether the error is generated, based on whether communication of the grip sensor 220 successes/fails, but there is no limitation therein. In an example, the application processor 210 may identify the error related to the grip sensor 220, based on at least one API associated with the error of the grip sensor 220, but there is no limitation therein. Various embodiments and methods of identifying the error related to the grip sensor 220 are described below.

According to an embodiment, the application processor 210 may provide information for causing backoff to the communication processor 230, based on identification of the error in operation 303. In an example, the application processor 210 may provide a signal for causing backoff to the communication processor 230 immediately in response to identification of the error. In an example, the application processor 210 may provide information for causing a mode change to the grip sensor 220 in response to identification of the error. In this case, the grip sensor 220 may change the operation mode from a first mode (in other words, also referred to as a general mode) to a second mode (in other words, also referred to as an unknown mode), based on reception of the information for causing the mode change. In the first mode, the grip sensor 220 may provide information indicating identification of the grip (for example, the first information) to the application processor 210 according to the identification of the grip and provide information indicating identification of the grip release (for example, the second information) to the application processor 210 according to the identification of the grip release. In the second mode, the grip sensor 220 may provide information indicating identification of the grip (for example, the first information) to the application processor 210 regardless of the grip. Accordingly, the application processor 210 may provide information for causing backoff to the communication processor 230 regardless of actual grip. Meanwhile, the operation mode such as the first mode/second mode may be defined as an operation mode of the application processor 210 and/or the communication processor 230 rather than the grip sensor 220. For example, in the first mode, the application processor 210 and/or the communication processor 230 may perform at least one operation for backoff, based on provision of the information indicating identification of the grip (for example, the first information) from the grip sensor 220. For example, in the second mode, the application processor 210 and/or the communication processor 230 may perform at least one operation for backoff regardless of whether the information (for example, the first information) is provided form the grip sensor 220. The second mode may be configured as an operation mode for example, when initial booting is performed, a travel adaptor (TA) is inserted, an ear jack is inserted, and/or a data cable is inserted as well as when the error related to the grip sensor 220 is generated. In an example, the electronic device 101 may return to the first mode when a termination event is identified in the second mode. The termination event may be detection of motion or detection of a series of events of grip (or touch) and grip release (or touch release) but there is no limitation. The event for detection of motion may be, for example, the successive number of motion of the electronic device 101 satisfying a condition larger than or equal to predetermined threshold number, based on the acceleration sensor, but there is no limitation. Meanwhile, when it is identified that the error related to the grip sensor 220 continues, the electronic device 101 may be configured to maintain the second mode as the operation mode in spite of detection of the termination event in the second mode.

According to an embodiment, the communication processor 230 may perform at least one operation for backoff, based on reception of information for causing the backoff in operation 305. As described above, the communication processor 230 may perform at least one operation for backoff, based on satisfaction of a single condition of reception of the information for causing the backoff or perform at least one operation for backoff, based on reception of the information for causing the backoff and satisfaction of at least one additional condition. As described above, even when the error related to the grip sensor 220 is generated, the electronic device 101 may perform backoff. Accordingly, although the user actually grips (or touches) the electronic device 101, the backoff can be prevented from being not performed by the error related to the grip sensor 220.

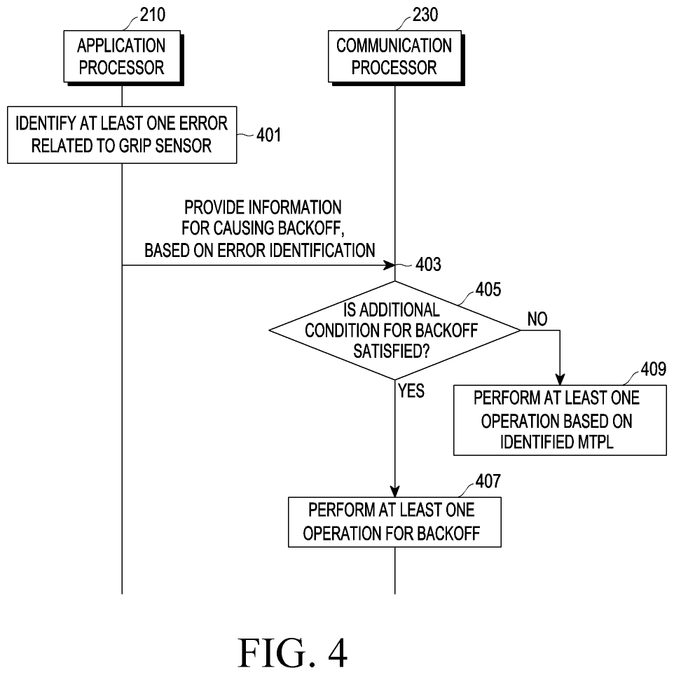

FIG. 4 is a signal flow diagram illustrating an example method of operating the electronic device according to various embodiments.

According to an embodiment, the application processor 210 may identify at least one error related to the grip sensor 220 in operation 401. According to an embodiment, the application processor 210 may provide information for causing backoff to the communication processor 230, based on identification of the error in operation 403. The communication processor 230 may identify whether an additional condition for backoff is satisfied in operation 405. When the additional condition for backoff is satisfied (Yes of operation 405), the communication processor 230 may perform at least one operation for backoff in operation 407. When the additional condition for backoff is not satisfied (No of operation 405), the communication processor 230 may perform at least one operation based on the identified MTPL in operation 409. The communication processor 230 may refrain from performing at least one operation for backoff and perform at least one operation based on the identified MTPL as the general mode.

In an example, the communication processor 230 may identify whether an operation band is a band requiring backoff, based on whether the additional condition for backoff is satisfied. For example, at least one first operation band (for example, an operation band included in a low band but there is no limitation) may require backoff, and at least one second operation band (for example, an operation band included in a mid band and a high band but there is no limitation) may not require backoff. The electronic device 101 may store whether each operation band requires backoff. When it is identified that the currently accessed operation band requires backoff, the electronic device 101 may perform at least one operation for backoff. When it is identified that the currently accessed operation band does not require backoff, the electronic device 101 may refrain from performing at least one operation for backoff.

In an example, the communication processor 230 may identify whether a transmission antenna for transmitting an RF signal is the same as an antenna corresponding to the grip sensor 220, based on whether the additional condition for backoff is satisfied. The communication processor 230 may change, for example, the transmission antenna. The communication processor 230 may change the transmission antenna, based on, for example, antenna hopping or antenna switching. According to the change in the transmission antenna, the transmission antenna may be the same as the antenna corresponding to the grip sensor 220 or the transmission antenna may be different from the antenna corresponding to the grip sensor 220. When the transmission antenna is the same as the antenna corresponding to the grip sensor 220, the communication processor 230 may perform at least one operation for backoff. When the transmission antenna is different from the antenna corresponding to the grip sensor 220, the communication processor 230 may refrain from performing at least one operation for backoff.

In an example, the communication processor 230 may identify whether a tuning mode of an antenna tuner is a grip mode or a free space mode, based on whether the additional condition for backoff is satisfied. For example, when the tuning mode of the antenna tuner is the grip mode, the communication processor 230 may perform at least one operation for backoff. When the tuning mode of the antenna tuner is the free space mode, the communication processor 230 may refrain from performing at least one operation for backoff.

In an example, the communication processor 230 may identify whether the transmission antenna for transmitting an RF signal and the antenna corresponding to the grip sensor 220 satisfy a predetermined condition, based on whether the additional condition for backoff is satisfied. For example, the predetermined condition may indicate whether antennas are in proximity to each other, and the condition indicating whether the antennas are in proximity to each other may indicate whether the distance between both antennas is within a threshold distance, but there is no limitation. For example, when the distance between both antennas is within the threshold distance, the communication processor 230 may perform at least operation for backoff. For example, when the distance between both antennas is the threshold distance or longer, the communication processor 230 may refrain from performing at least one operation for backoff.

In an example, the communication processor 230 may identify whether the additional condition is satisfied, based on generated RF exposure (SAR and/or PD) accumulated for a predetermined time period. The communication processor 230 may identify the remaining RF exposure margin for a predetermined time period, based on the accumulated generated RF exposure. For example, when the RF exposure expected in the case in which backoff is not performed is larger than the RF exposure margin, the communication processor 230 may perform at least one operation for backoff. For example, when the RF exposure expected in the case in which backoff is not performed is equal to or smaller than the RX exposure margin, the communication processor 230 may refrain from performing at least one operation for backoff.

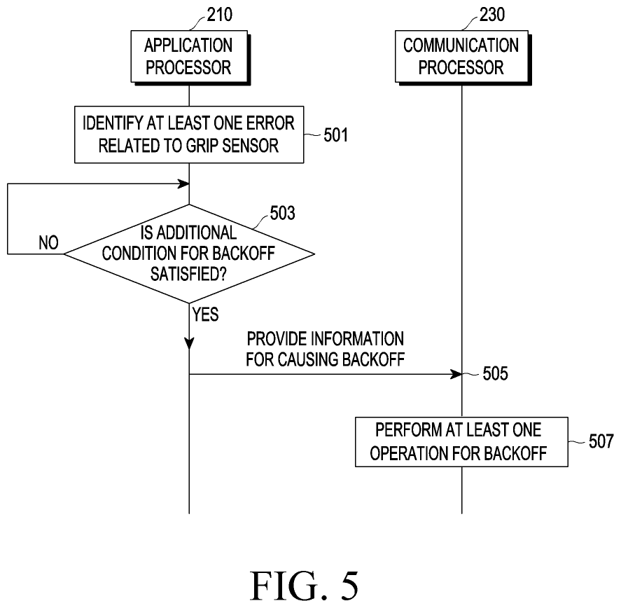

FIG. 5 is a signal flow diagram illustrating an example method of operating the electronic device according to various embodiments.

According to an embodiment, the application processor 210 may identify at least one error related to the grip sensor 220 in operation 501. According to an embodiment, the application processor 210 may identify whether an additional condition for backoff is satisfied, based on identification of the error in operation 503. The application processor 210 may identify a condition for determining whether the electronic device 101 is used as the additional condition for backoff. For example, the application processor 210 may identify whether the display 160 is turned on as the additional condition for backoff. For example, the application processor 210 may identify whether a user touch is detected through the touch sensor as the additional condition for backoff. For example, the application processor 210 may identify whether motion is identified through the acceleration sensor as the additional condition for backoff. For example, when motion is identified, it is likely that the user uses the electronic device 101, and thus the application processor 210 may identify that the additional condition is satisfied. For example, when motion is not identified, it is likely that the user does not grip the electronic device 101, and thus the application processor 210 may identify that the additional condition is not satisfied.

Meanwhile, the additional condition for determining whether the user uses the electronic device is only an example, and there is no limitation in the additional condition. Meanwhile, the application processor 210 may identify at least some of the additional conditions identified by the communication processor 230 described in FIG. 4 may be identified as additional conditions. At least some of the additional conditions identified by the application processor 210 described in FIG. 5 may be identified as the additional conditions by the communication processor 230 of FIG. 4. When the additional conditions for backoff are satisfied (Yes of operation 503), the application processor 210 may provide information for causing backoff to the communication processor 230 in operation 505. The communication processor 230 may perform at least one operation for backoff in operation 507. When the information for causing backoff is not provided, the communication processor 230 may perform at least one operation based on the identified MTPL. The communication processor 230 may refrain from performing at least one operation for backoff and perform at least one operation based on the identified MTPL as the general mode.

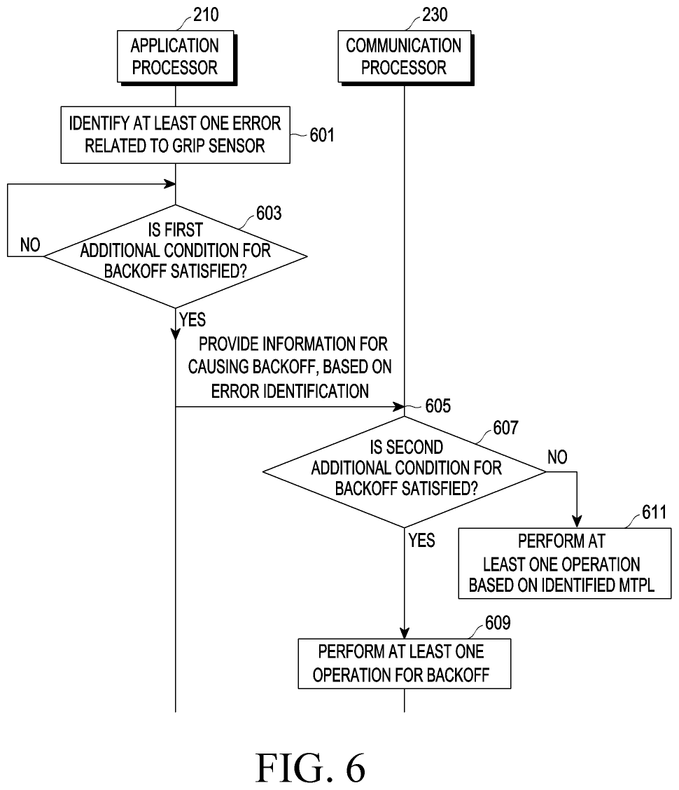

FIG. 6 is a signal flow diagram illustrating an example method of operating the electronic device according to various embodiments.

According to an embodiment, the application processor 210 may identify at least one error related to the grip sensor 220 in operation 601. According to an embodiment, the application processor 210 may identify whether a first additional condition for backoff is satisfied based on identification of the error in operation 603. The application processor 210 may identify at least one some of the additional conditions described with reference to FIG. 4 and the additional conditions described with reference to FIG. 5 as the first additional condition for backoff. When the first additional condition for backoff is satisfied (Yes of operation 603), the application processor 210 may provide information for causing backoff to the communication processor 230 in operation 605. The communication processor 230 may identify whether a second additional condition for backoff is satisfied in operation 607. The communication processor 230 may identify at least some of the additional conditions described with reference to FIG. 4 and the additional conditions described with reference to FIG. 5 as the second additional condition for backoff. When the second additional condition for backoff is satisfied (Yes of operation 607), the communication processor 230 may perform at least one operation for backoff in operation 609. When the second additional condition for backoff is not satisfied (No of operation 607), the communication processor 230 may perform at least one operation based on the identified MTPL in operation 611. The communication processor 230 may refrain from performing at least one operation for backoff and perform at least one operation based on the identified MTPL as the general mode.

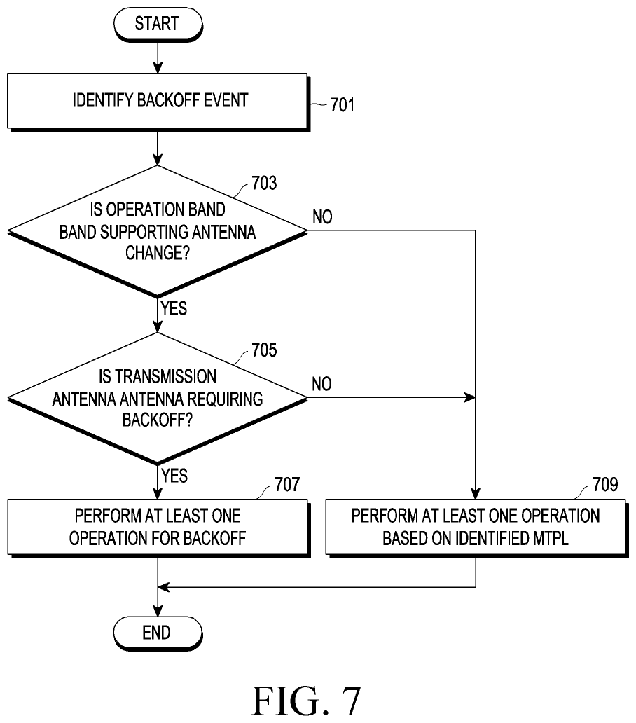

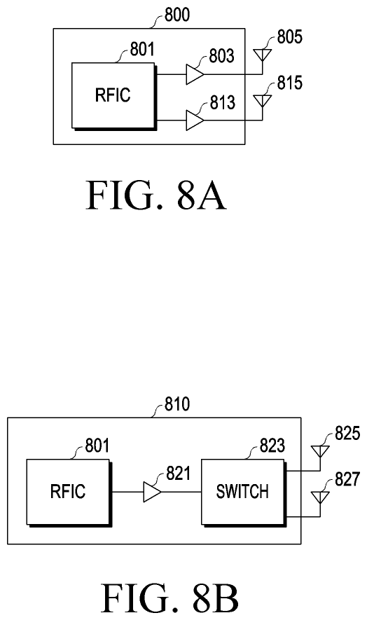

FIG. 7 is a flowchart illustrating an example method of operating the electronic device according to various embodiments. FIG. 7 is described with reference to FIGS. 8A and 8B. FIGS. 8A and 8B are diagrams illustrating a change in a transmission antenna according to various embodiments.

According to an embodiment, the electronic device 101 (for example, the communication processor 230) may identify a backoff event in operation 701. For example, the electronic device 101 may identify information for causing the backoff provided from the application processor 210 as the backoff event. The electronic device 101 may identify whether an operation band is a band supporting an antenna change in operation 703. As described above, the electronic device 101 may change a transmission antenna, based on antenna hopping or antenna switching. For example, referring to FIG. 8A, an RF circuit 800 of the electronic device 101 may include an RFIC 801 and/or a plurality of PAs 803 and 813. It is understood by those skilled in the art that the plurality of PAs 803 and 813 may be included in at least one RFFE. A first antenna 805 may be connected to the first PA 803, and a second antenna 815 may be connected to the second PA 813. For example, an RF signal may be provided to the first antenna 805 through the first PA 803, and an RF path to the first antenna 805 through the first PA 803 may be referred to as a first RF path. For example, an RF signal may be provided to the second antenna 815 through the second PA 813, and an RF path to the second antenna 815 through the second PA 813 may be referred to as a second RF path. The RF path may be, for example, a path to which the RF signal is applied or at least some of a plurality of hardware associated with the path. The electronic device 101 may support a function for changing the transmission antenna. The electronic device 101 may determine, for example, provision of the RF signal through the first RF path. In this case, the electronic device 101 may provide the RF signal to the first PA 803 and, accordingly, provide an RF signal amplified by the first PA 803 to the first antenna 805. The electronic device 101 may identify that, for example, a condition for the change in the RF path is satisfied. For example, a first index indicating at least one performance corresponding to the first RF path more deteriorates than a second index indicating at least one performance corresponding to a second RF path (or when the first index and the second index satisfy a preset condition), the electronic device 101 may change the RF path from the first RF path to the second RF path. There is no limitation in the preset condition associated with the first index and the second index. The electronic device 101 may change the RF path from the first RF path to the second RF path by controlling at least some of the RF circuit 800. Accordingly, the RF signal may be provided to the second PA 813, and the RF signal amplified by the second PA 813 may be provided to the second antenna 815. As described above, the transmission antenna for the RF signal may be changed from the first antenna 805 to the second antenna 815, which may be referred as transmission antenna hopping.

Referring to FIG. 8B, the RF circuit 810 of the electronic device 101 may include an RFIC 801, a PA 821, and/or a switch 823. The switch 823 may selectively connect one of the first antenna 825 or the second antenna 827 to the PA 821. For example, the switch 823 may operate based on the control of the communication processor 230 and/or the RFIC 801, but there is no limitation. It is understood by those skilled in the art that the switch 823 is implemented as SPnT but there is no limitation in the type thereof. For example, in the example of FIG. 8B, the switch 823 may be controlled to provide the RF signal to the first antenna 825 through the PA 821, which may be referred to as a first RF path. For example, the switch 823 may be controlled to provide the RF signal to the second antenna 827 through the PA 821, which may be referred to as a second RF. The electronic device 101 may support a function for changing the transmission antenna. The electronic device 101 may determine, for example, provision of the RF signal through the first RF path. In this case, the electronic device 101 may control the switch 823 to provide the RF signal to the first PA 821 and, accordingly, provide the RF signal amplified by the first PA 821 to the first antenna 825. The electronic device 101 may identify that, for example, a condition for the change in the RF path is satisfied. For example, a first index indicating at least one performance corresponding to the first RF path more deteriorates than a second index indicating at least one performance corresponding to a second RF path (or when the first index and the second index satisfy a preset condition), the electronic device 101 may change the RF path from the first RF path to the second RF path. As described above, the antenna change may be made based on the various schemes as described above, and there is the operation band supporting the antenna change and the operation band which does not support the antenna change. The electronic device 101 may identify whether the currently used operation band is the band supporting the antenna change.

When the operation band is the band supporting the antenna change (Yes of operation 703), the communication processor 230 may identify whether the transmission antenna is an antenna requiring backoff in operation 705. When the transmission antenna is an antenna requiring backoff (Yes of operation 705), the communication processor 230 may perform at least one operation for backoff in operation 707. When the operation band is not the band supporting the antenna change (No of operation 703) or the transmission antenna is not the antenna requiring backoff (No of operation 705), the communication processor 230 may perform at least one operation based on the identified MTPL in operation 709. The communication processor 230 may refrain from performing at least one operation for backoff and perform at least one operation based on the identified MTPL as the general mode.

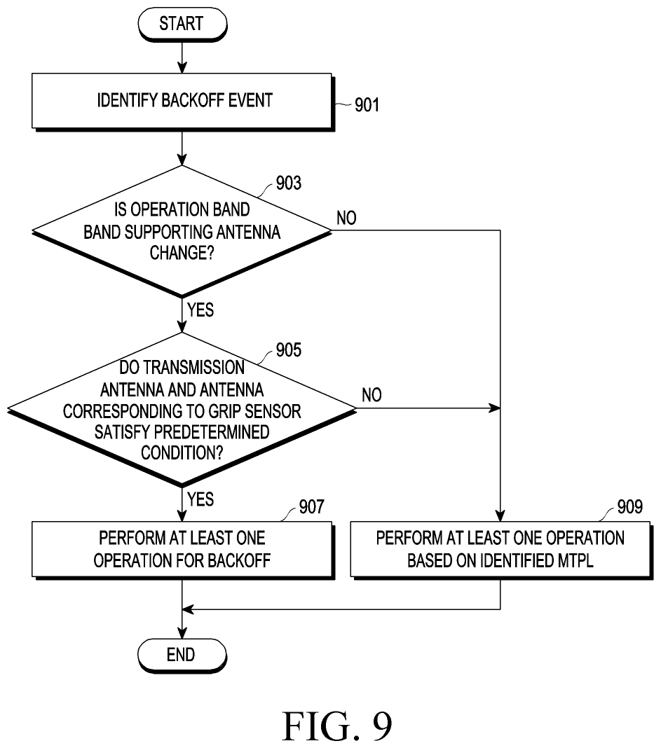

FIG. 9 is a flowchart illustrating an example method of operating the electronic device according to various embodiments.

According to an embodiment, the electronic device 101 (for example, the communication processor 230) may identify a backoff event in operation 901. For example, the electronic device 101 may identify information for causing the backoff provided from the application processor 210 as the backoff event. The electronic device 101 may identify whether an operation band is a band supporting an antenna change in operation 903. As described above, the electronic device 101 may change the transmission antenna, based on antenna hopping or antenna switching, and may identify whether the currently used operation band is the band supporting the antenna change. When the operation band is the band supporting the antenna change (Yes of operation 903), the communication processor 230 may identify whether the transmission antenna and the antenna corresponding to the grip sensor satisfy a predetermined condition in operation 905. For example, the communication processor 230 may identify whether the predetermined condition is satisfied, based on whether the distance between the transmission antenna and the grip sensor is within a threshold distance. When the distance between the transmission antenna and the grip sensor is within the threshold distance (Yes of operation 905), the communication processor 230 may perform at least one operation for backoff in operation 907. When the operation band is not the band supporting the antenna change (No of operation 903) or the transmission antenna and the grip sensor is longer than or equal to the threshold distance (No of operation 905), the communication processor 230 may perform at least one operation based on the identified MTPL in operation 909. The communication processor 230 may refrain from performing at least one operation for backoff and perform at least one operation based on the identified MTPL as the general mode.

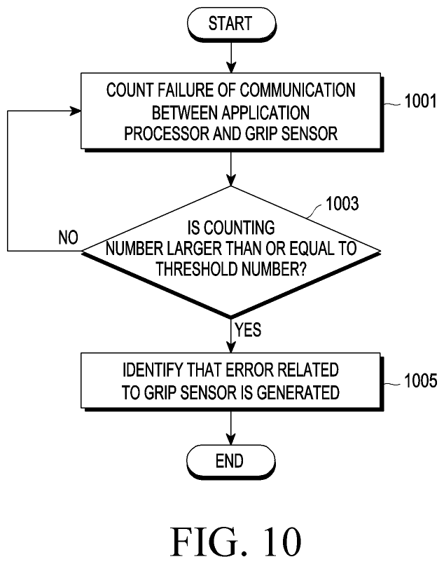

FIG. 10 is a flowchart illustrating an example method of operating the electronic device according to various embodiments.

In an embodiment, the application processor 210 may count communication failure between the application processor 210 and the grip sensor 220 in operation 1001. For example, when a communication line (for example, I2C) between the application processor 210 and the grip sensor 220 has an error or when the grip sensor 220 has an error, the application processor 210 may fail in data reception from the grip sensor 220 and/or data transmission to the grip sensor 220. The application processor 210 may identify whether the counting number is larger than or equal to a threshold number (for example, three times but there is no limitation) in operation 1003. When the counting number is larger than or equal to the threshold number (Yes of operation 1003), the application processor 210 may identify that an error related to the grip sensor 220 is generated in operation 1005. For example, the application processor 210 may identify whether communication fails based on an API such as an I2C Read API, but there is no limitation in an identification scheme thereof. For example, the counting number may increase based on identification of successive communication failure and may be updated to 0 when communication success is identified, but those skilled in the art may understand that there is no limitation in the counting scheme thereof. Meanwhile, although FIG. 10 illustrates that the application processor 210 counts communication failure and determines whether the error related to the grip sensor 220, it is only an example and the grip sensor 220 may count communication failure and determine whether the error related to the grip sensor 220 is generated and, when the generation of the error is identified, notify the application processor 210 of the generation of the error (For example, a specific error code). The application processor 210 may provide information for causing backoff to the communication processor 230, based on the generation of the error related to the grip sensor.

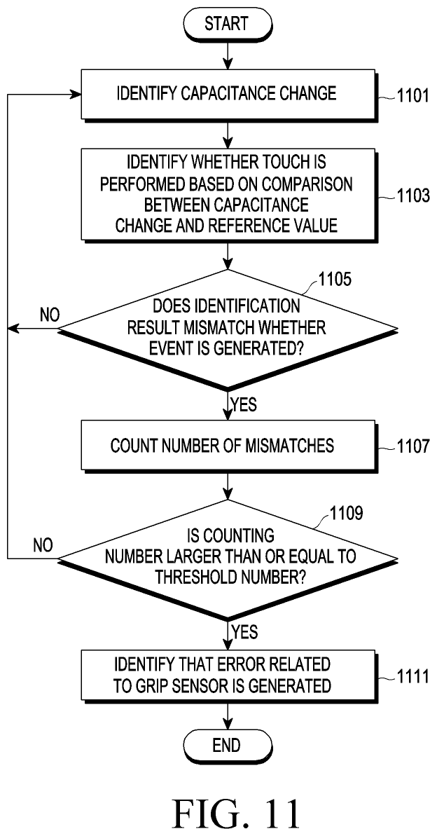

FIG. 11 is a flowchart illustrating an example method of operating the electronic device according to various embodiments.

According to an embodiment, the grip sensor 220 may identify a change in capacitance related to a conductor in operation 1101. The grip sensor 220 may identify whether there is a touch, based on comparison between the capacitance change and a reference value in operation 1103. The grip sensor 220 may identify whether the identification result matches whether an event is generated in operation 1105. For example, when the capacitance change is larger than or equal to the reference value, it is likely to fail in generation of a grip event (or grip interrupt) even though the grip event (or grip interrupt) should be generated. When the identification result does mismatch whether the event is generated (Yes of operation 1105), the grip sensor 220 may count the number of mismatches in operation 1107. The grip sensor 220 may identify whether the counting number is larger than or equal to a threshold number (for example, three times but there is no limitation) in operation 1109. When the counting number is larger than or equal to the threshold number (for example, three times but there is no limitation), the grip sensor 220 may identify that the error related to the grip sensor 220 is generated in operation 1111. For example, the counting number may increase based on identification of successive mismatches and may be updated to 0 when the matching is identified, but those skilled in the art that there is no limitation in a counting scheme thereof. The grip sensor 220 may inform the application processor 210 of the generation of the error. An identification cycle may be, for example, 2 to 20 seconds, and SAR regulation violation possibility may decrease but current consumption may increase as the identification cycle is smaller. Accordingly, the identification cycle may be determined in consideration of tradeoff, and there is limitation in a value thereof. The application processor 210 may provide information for causing backoff to the communication processor 230, based on the generation of the error related to the grip sensor 220.

Meanwhile, although FIG. 11 illustrates that the grip sensor 220 counts whether the result of comparison between the capacitance change and the threshold value mismatch the generation of the event and determines whether the error related to the grip sensor 220 is generated, it is only an example and those skilled in the art understand that the application processor 210 makes the determination.

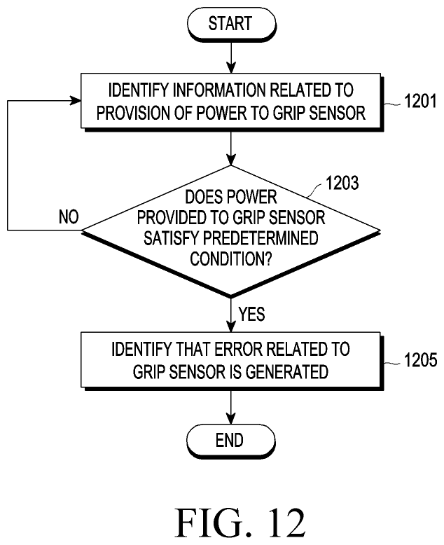

FIG. 12 is a flowchart illustrating an example method of operating the electronic device according to various embodiments.

According to an embodiment, the application processor 210 may identify information related to provision of power for the grip sensor 220 in operation 1201. The application processor 210 may identify whether the power provided to the grip sensor 220 satisfies a predetermined condition in operation 1203. When it is identified that the power provided to the grip sensor 220 satisfies the predetermined condition (Yes of operation 1203), the application processor 210 may identify that the error related to the grip sensor 220 is generated in operation 1205. For example, as whether the predetermined condition is satisfied, the application processor 210 may identify whether the sensing result (for example, voltage, current, power, and/or impedance) at at least one point (for example, an input point of the driving voltage (VDD)) of the grip sensor 220 escapes a predetermined range. The predetermined range may be a range allowed for a normal operation of the grip sensor 220. When it is determined that the driving voltage (VDD) escapes a predetermined voltage range, the application processor 210 may identify that the error related to the grip sensor 220 is generated. When power is abnormally provided to the grip sensor 220, the application processor 210 may identify information indicating that there is no grip sensor 220 (for example, expressed as no such device but there is no limitation in an express scheme thereof) and, accordingly, may identify that the error related to the grip sensor 220 is generated. The application processor 210 may provide information for causing backoff to the communication processor 230, based on the generation of the error related to the grip sensor.

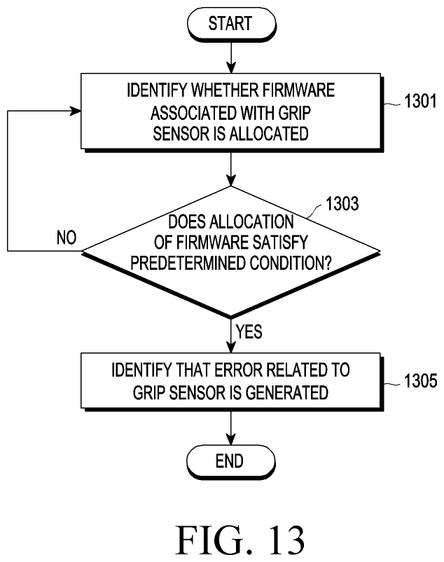

FIG. 13 is a flowchart illustrating an example method of operating the electronic device according to various embodiments.

According to an embodiment, the application processor 210 may identify whether firmware associated with the grip sensor 220 is allocated to, for example, the memory 130 when initial booting is performed in operation 1301. The application processor 210 may identify whether firmware allocation satisfies a predetermined condition in operation 1303. For example, when firmware is not allocated to the memory 130, the application processor 210 may identify that the predetermined condition is satisfied but there is no limitation. When firmware allocation does not satisfy the predetermined condition (Yes of operation 1303), the application processor 210 may identify that the error related to the grip sensor 220 is generated in operation 1305. The application processor 210 may provide information for causing backoff to the communication processor 230, based on the generation of the error related to the grip sensor.

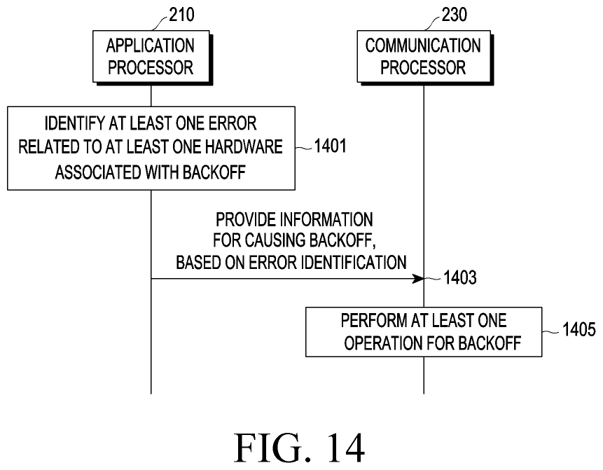

FIG. 14 is a signal flow diagram illustrating an example method of operating the electronic device according to various embodiments.

According to an embodiment, the application processor 210 may identify at least one error related to at least one hardware component associated with backoff in operation 1401. For example, as described above, since backoff can be caused based on grip interrupt from the grip sensor 220, the grip sensor 220 may be at least one hardware component related to backoff. The electronic device 101 may be implemented to not include the grip sensor 220 and may be implemented to identify whether the electronic device is gripped based on sensing data from the motion sensor. In this case, the motion sensor may be at least one hardware component related to backoff. The electronic device 101 may determine whether the user is in proximity thereto, based on sensing data from the proximity sensor and may be implemented to perform backoff when the user is in proximity thereto. In this case, the proximity sensor may be at least one hardware component related to backoff. As described above, various types of events causing backoff may be configured, and various types of hardware for detecting the corresponding events may be configured as at least one hardware component related to backoff. The application processor 210 may identify at least some errors of at least one hardware component related to backoff. The application processor 210 may provide information for causing backoff to the communication processor 230, based on identification of the error in operation 1403. According to an embodiment, the communication processor 230 may perform at least one operation for backoff, based on reception of information for causing the backoff in operation 1405. As described above, the communication processor 230 may perform at least one operation for backoff, based on satisfaction of a single condition of reception of the information for causing the backoff or perform at least one operation for backoff, based on reception of the information for causing the backoff and satisfaction of at least one additional condition. According to the above description, even when the error related to at least some of the hardware for determining whether backoff is performed is generated, the electronic device 101 may perform backoff. Accordingly, even though an event for backoff is generated, the backoff may be prevented from being not performed by the error related to hardware for sensing the corresponding event.

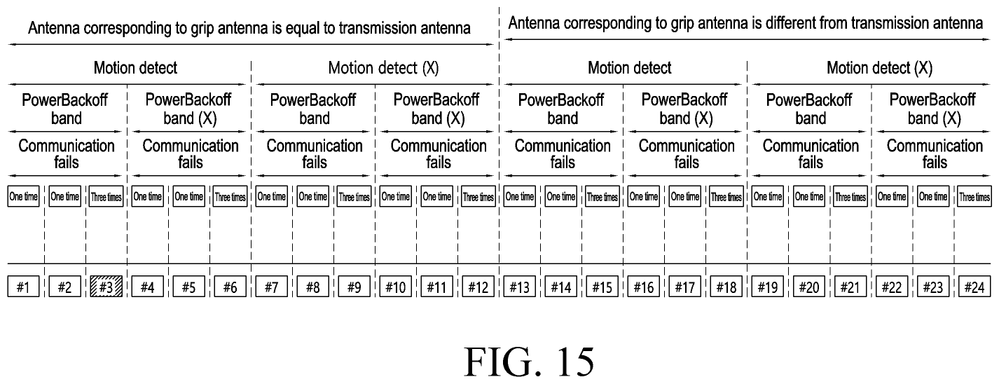

FIG. 15 is a diagram illustrating whether the electronic device performs backoff according to various embodiments.

According to an embodiment, the electronic device 101 may perform backoff when an antenna corresponding to the grip sensor 220 corresponds to a transmission antenna, and may refrain from performing backoff while the antenna corresponding to the grip sensor 220 does not correspond to the transmission antenna. The electronic device 101 may perform backoff while motion is detected and refrain from performing backoff while no motion is detected. The electronic device 101 may perform backoff in the case of an operation band requiring backoff and refrain from performing backoff in the case of an operation band which does not require backoff. The electronic device 101 may be configured to perform backoff when an error related to the grip sensor 220 is generated (for example, when the number of I2C communication failures is three times or more). Accordingly, as illustrated in FIG. 15, the backoff can be performed in an occasion (for example, occasion #3) in which the conditions for backoff are satisfied among all occasions, and the backoff can be prevented/reduced from being performed in an unnecessary occasion.

According to an example embodiment, the electronic device may include: at least one application processor, comprising processing circuitry, at least one communication processor, comprising processing circuitry operatively connected to at least one application processor, and at least one grip sensor operatively connected to at least one application processor. At least one application processor, individually and/or collectively, may be configured to: identify an error related to at least some of the at least one grip sensor; provide information for causing backoff to at least one communication processor, based on identification of the error; wherein at least one communication processor, individually and/or collectively, may be configured to: receive the information for causing the backoff; and perform at least one operation for backoff, based on reception of the information for causing the backoff.

According to an example embodiment, at least one communication processor, individually and/or collectively, may be configured to perform at least one operation for the backoff, based on identification of the reception of the information for causing the backoff and identification of satisfaction of at least one first additional condition, as at least a portion of an operation for performing the at least one operation for the backoff.

According to an example embodiment, at least one communication processor, individually and/or collectively, may be configured to determine whether a current operation band of the electronic device is a band requiring backoff, based on whether the at least one first additional condition is satisfied, as at least a portion of an operation for performing the at least one operation for the backoff.

According to an example embodiment, the electronic device may further include at least one RF circuit operatively connected to at least one communication processor and a plurality of antennas connected to the at least one RF circuit At least one communication processor, individually and/or collectively, may be configured to determine whether transmission antennas selected from the plurality of antennas are equal to at least some of at least one antenna connected to the at least one grip sensor, based on whether the at least one first additional condition is satisfied, as at least a portion of an operation for performing the at least one operation for the backoff.

According to an example embodiment, the electronic device may further include at least one RF circuit operatively connected to at least one communication processor and a plurality of antennas connected to the at least one RF circuit At least one communication processor, individually and/or collectively, may be configured to determine whether distances between transmission antennas selected from the plurality of antennas and at least some of at least one antenna connected to the at least one grip sensor among the plurality of antennas are within a threshold distance, based on whether the at least one first additional condition is satisfied, as at least a portion of an operation for performing the at least one operation for the backoff.

According to an example embodiment, at least one communication processor, individually and/or collectively, may be configured to: identify generated RF exposure accumulated for a first time period, identify remaining RF exposure margin for the first time period, based on the accumulated generated RF exposure, and determine whether RF exposure expected based on the backoff not being performed is larger than the RF exposure margin, based on whether the at least one first additional condition is satisfied, as at least a portion of an operation for performing the at least one operation for the backoff.

According to an example embodiment, the electronic device may further include at least one RF circuit operatively connected to at least one communication processor and a plurality of antennas connected to the at least one RF circuit At least one communication processor, individually and/or collectively, may be configured to determine whether an antenna tuning mode for transmission antennas selected from the plurality of antennas is a grip mode, based on whether the at least one first additional condition is satisfied, as at least a portion of an operation for performing the at least one operation for the backoff.

According to an example embodiment, at least one application processor, individually and/or collectively, may be configured to provide information for causing the backoff, based on identification of the error and identification of satisfaction of at least one second additional condition, as at least a portion of an operation for providing the information for causing backoff to at least one communication processor.

According to an example embodiment, at least one application processor, individually and/or collectively, may be configured to determine whether a display included in the electronic device is turned off, based on whether the at least one second additional condition is satisfied, as at least a portion of an operation for providing information for causing the backoff to at least one communication processor.

According to an example embodiment, at least one application processor, individually and/or collectively, may be configured to determine whether motion sensed through a motion sensor included in the electronic device is not identified based on whether the at least one second additional condition is satisfied, as at least a portion of an operation for providing information for causing the backoff to at least one communication processor.

According to an example embodiment, at least one application processor, individually and/or collectively, may be configured to determine whether a touch is not identified through a touch sensor included in the electronic device, based on whether the at least one second additional condition is satisfied, as at least a portion of an operation for providing information for causing the backoff to at least one communication processor.

According to an example embodiment, at least one application processor, individually and/or collectively, may be configured to identify the error, based on reception of information indicating the error from the at least one grip sensor and/or identify the error, based on satisfaction of a condition for determining whether the error is generated, as at least a portion of an operation for identifying the error.

According to an example embodiment, the error may be identified based on satisfaction of a condition associated with failure of communication between at least one application processor and the at least one grip sensor.

According to an example embodiment, the error may be identified based on satisfaction of a condition associated with mismatch between a sensing result by the at least one grip sensor and an event generation result indicating whether sensing is performed.

According to an example embodiment, the error may be identified based on satisfaction of a condition associated with provision of power to the at least one grip sensor. According to an example embodiment, the error may be identified based on satisfaction of a condition associated with allocation of firmware to the at least one grip sensor.

According to an example embodiment, a method of operating an electronic device including at least one application processor, at least one communication processor operatively connected to the at least one application processor, and at least one grip sensor operatively connected to at least one application processor is provided. The method includes: identifying an error related to at least some of the at least one grip sensor by at least one application processor; providing information for causing backoff to at least one communication processor, based on identification of the error by the at least one application processor; receiving the information for causing the backoff by at least one communication processor; and performing at least one operation for the backoff, based on reception of the information for causing the backoff by at least one communication processor.

According to an example embodiment, the performing the at least one operation for the backoff may include performing the at least one operation for the backoff, based on identification of the reception of the information for causing the backoff and identification of satisfaction of at least one first additional condition.

According to an example embodiment, the performing the at least one operation for the backoff may include determining whether a current operation band of the electronic device is a band requiring backoff, based on whether the at least one first additional condition is satisfied.

According to an example embodiment, in the performing the at least one operation for the backoff, at least one communication processor may determine whether transmission antennas selected from the plurality of antennas included in the electronic device are equal to at least some of at least one antenna connected to the at least one grip sensor among the plurality of antennas, based on whether the at least one first additional condition is satisfied.

According to an example embodiment, in the performing the at least one operation for the backoff, at least one communication processor may determine whether distances between transmission antennas selected from the plurality of antennas of the electronic device and at least some of at least one antenna connected to the at least one grip sensor among the plurality of antennas are within a threshold distance, based on whether the at least one first additional condition is satisfied.

According to an example embodiment, in the performing the at least one operation for the backoff, at least one communication processor may identify generated RF exposure accumulated for a first time period, identify remaining RF exposure margin for the first time period, based on the accumulated generated RF exposure, and determine whether RF exposure expected based on the backoff not being performed is larger than the RF exposure margin, based on whether the at least one first additional condition is satisfied.

According to an example embodiment, the performing the at least one operation for the backoff may determine whether an antenna tuning mode for transmission antennas selected from the plurality of antennas included in the electronic device is a grip mode, based on whether the at least one first additional condition is satisfied.

According to an example embodiment, the providing information for causing the backoff to at least one communication processor may provide information for causing the backoff, based on identification of the error and identification of satisfaction of at least one second additional condition.

According to an example embodiment, the providing information for causing the backoff to at least one communication processor may determine whether a display included in the electronic device is turned off, based on whether the at least one second additional condition is satisfied.

According to an example embodiment, the providing information for causing the backoff to at least one communication processor may determine whether motion sensed through a motion sensor included in the electronic device is not identified based on whether the at least one second additional condition is satisfied.

According to an example embodiment, the providing information for causing the backoff to at least one communication processor may determine whether a touch is not identified through a touch sensor included in the electronic device, based on whether the at least one second additional condition is satisfied.

According to an example embodiment, the identifying the error may identify the error, based on reception of information indicating the error from the at least one grip sensor and/or identify the error, based on satisfaction of a condition for determining whether the error is generated.

According to an example embodiment, the error may be identified based on satisfaction of a condition associated with failure of communication between at least one application processor and the at least one grip sensor.

According to an example embodiment, the error may be identified based on satisfaction of a condition associated with mismatch between a sensing result by the at least one grip sensor and an event generation result indicating whether sensing is performed.

According to an example embodiment, the error may be identified based on satisfaction of a condition associated with provision of power to the at least one grip sensor. According to an example embodiment, the error may be identified based on satisfaction of a condition associated with allocation of firmware to the at least one grip sensor.

According to an example embodiment, an electronic device may include at least one application processor, comprising processing circuitry, and at least one communication processor, comprising processing circuitry, operatively connected to at least one application processor. At least one application processor, individually and/or collectively, may be configured to identify an error related to at least some of at least one hardware associated with backoff of at least one communication processor; provide information for causing backoff to at least one communication processor, based on identification of the error; receive information for causing the backoff; perform at least one operation for backoff, based on reception of the information for causing the backoff.

According to an example embodiment, a method of operating an electronic device including at least one application processor and at least one communication processor operatively connected to at least one application processor may include: identifying an error related to at least some of at least one hardware associated with backoff of at least one communication processor by at least one application processor; providing information for causing backoff to at least one communication processor, based on identification of the error by at least one application processor; receiving the information for causing the backoff by at least one communication processor; and performing at least one operation for the backoff, based on reception of the information for causing the backoff by at least one communication processor.

The electronic device according to an embodiment may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that an embodiment of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with an embodiment of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to an embodiment, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
at least one application processor, comprising processing circuitry;
at least one communication processor, comprising processing circuitry, operatively connected to at least one application processor; and
at least one grip sensor operatively connected to at least one application processor,
memory storing instructions that, when executed by the at least one application processor and/or at least one communication processor, cause the electronic device to:
identify an error related to at least one of the at least one grip sensor; and
provide, by at least one application processor, information for causing backoff to at least one communication processor, based on the identification of the error, and
receive, by at least one communication processor, the information for causing the backoff; and
perform at least one operation for the backoff, based on the reception of the information for causing the backoff.

2. The electronic device of claim 1, wherein the instructions cause the electronic device to perform, by the at least one communication processor, at least one operation for the backoff, based on identification of the reception of the information for causing the backoff and identification of satisfaction of at least one first additional condition, as at least a portion of performing the at least one operation for the backoff.

3. The electronic device of claim 1, wherein the instructions cause the electronic device to determine, by the at least one communication processor, whether a current operation band of the electronic device is a band requiring backoff, based on whether the at least one first additional condition is satisfied, as at least a portion of performing the at least one operation for the backoff.

4. The electronic device of claim 1, further comprising:
at least one RF circuit operatively connected to at least one communication processor; and
a plurality of antennas connected to the at least one RF circuit,
wherein the instructions cause the electronic device to: determine, by at least one communication processor, whether transmission antennas selected from the plurality of antennas are equal to at least some of at least one antenna connected to the at least one grip sensor among the plurality of antennas, based on whether the at least one first additional condition is satisfied, as at least a portion of performing the at least one operation for the backoff.

5. The electronic device of claim 1, further comprising:
at least one RF circuit operatively connected to at least one communication processor; and
a plurality of antennas connected to the at least one RF circuit,
wherein the instructions cause the electronic device to: determine, by at least one communication processor, whether distances between transmission antennas selected from the plurality of antennas and at least some of at least one antenna connected to the at least one grip sensor among the plurality of antennas are within a threshold distance, based on whether the at least one first additional condition is satisfied, as at least a portion of performing the at least one operation for the backoff.

6. The electronic device (of claim 1, wherein the instructions cause the electronic device to:
identify, by at least one communication processor, generated RF exposure accumulated for a first time period;
identify, by at least one communication processor, remaining RF exposure margin for the first time period, based on the accumulated generated RF exposure; and
determine, by at least one communication processor, whether RF exposure expected based on the backoff not being performed is larger than the RF exposure margin, based on whether the at least one first additional condition is satisfied.

7. The electronic device of claim 1, further comprising:
at least one RF circuit operatively connected to at least one communication processor; and
a plurality of antennas connected to the at least one RF circuit,
wherein the instructions cause the electronic device to determine, by at least one communication processor, whether an antenna tuning mode for transmission antennas selected from the plurality of antennas is a grip mode, based on whether the at least one first additional condition is satisfied, as at least a portion of performing the at least one operation for the backoff.

8. The electronic device of claim 1, wherein the instructions cause the electronic device to provide, by at least one application processor, information for causing the backoff, based on identification of the error and identification of satisfaction of at least one second additional condition, as at least a portion of providing the information for causing backoff to at least one communication processor.

9. The electronic device of claim 1, wherein the instructions cause the electronic device to determine, by at least one application processor, whether a display included in the electronic device is turned off, based on whether the at least one second additional condition is satisfied, as at least a portion of providing information for causing the backoff to the at least one communication processor.

10. The electronic device of claim 1, wherein the instructions cause the electronic device to determine, by at least one application processor, whether motion sensed through a motion sensor included in the electronic device is not identified based on whether the at least one second additional condition is satisfied, as at least a portion of providing information for causing the backoff to at least one communication processor.

11. The electronic device of claim 1, wherein the instructions cause the electronic device to determine, by at least one application processor, whether a touch is not identified through a touch sensor included in the electronic device, based on whether the at least one second additional condition is satisfied, as at least a portion of providing information for causing the backoff to at least one communication processor.

12. The electronic device of claim 1, wherein the instructions cause the electronic device to identify, by at least one application processor, the error, based on reception of information indicating the error from the at least one grip sensor and/or identify the error, based on satisfaction of a condition for determining whether the error is generated, as at least a portion of identifying the error.

13. The electronic device of claim 1, wherein the error is identified based on satisfaction of a condition associated with failure of communication between at least one application processor and the at least one grip sensor.

14. The electronic device of claim 1, wherein the error is identified based on satisfaction of a condition associated with mismatch between a sensing result by the at least one grip sensor and an event generation result indicating whether sensing is performed.

15. The electronic device of claim 1, wherein the error is identified based on satisfaction of a condition associated with provision of power to the at least one grip sensor.

16. The electronic device of claim 1, wherein the error is identified based on satisfaction of a condition associated with allocation of firm ware to the at least one grip sensor.

17. A method of operating an electronic device comprising at least one application processor, at least one communication processor operatively connected to at least one application processor, and at least one grip sensor operatively connected to at least one application processor, the method comprising:
identifying an error related to at least some of the at least one grip sensor by at least one application processor;
providing information for causing backoff to at least one communication processor, based on identification of the error by at least one application processor;
receiving the information for causing the backoff by at least one communication processor; and
performing at least one operation for the backoff, based on reception of the information for causing the backoff by at least one communication processor.

18. The method of claim 17, wherein the performing of the at least one operation for the backoff comprises performing the at least one operation for the backoff, based on identification of the reception of the information for causing the backoff and identification of satisfaction of at least one first additional condition.

19. The method of claim 17, wherein the providing of the information for causing the backoff to at least one communication processor comprises providing the information for causing the backoff, based on identification of the error and identification of satisfaction of at least one second additional condition.

20. An electronic device comprising:
at least one application processor, comprising processing circuitry; and
at least one communication processor, comprising processing circuitry, operatively connected to at least one application processor,
memory storing instructions that, when executed by the at least one application processor cause the electronic device to:
identify an error related to at least some of at least one hardware associated with backoff of at least one communication processor;
provide information for causing backoff to at least one communication processor, based on identification of the error;
receive the information for causing the backoff; and
perform at least one operation for the backoff, based on reception of the information for causing the backoff.
